(19) United States
(12) Patent Application Publication
(10) Pub. No.: US 2007/0115343 A1
(43) Pub. Date: May 24, 2007

(54) Electronic equipment and methods of generating text in electronic equipment

(75) Inventor: Simon Lessing, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/284,648

(22) Filed: Nov. 22, 2005

(51) Int. Cl. H04N 7/14

(52) U.S. Cl. 348/14.01

(57) ABSTRACT

An electronic device includes a text input device enabling a user to input text information, a predictive text device configured to determine at least one predictive text candidate on the basis of input text information, a camera device configured to capture a moving image of a user, a detecting device configured to detect at least one word or word part on the basis of a user's lip movement in the captured moving image, a determining device configured to determine at least one most likely text on the basis of the at least one predictive text candidate determined by the predictive text device and the at least one word or word part detected by the detecting device, and a display device configured to display the at least one most likely text determined by the determining device. Methods for generating text on such electronic equipment is also discussed.

### FIELD OF THE INVENTION

The present invention relates to an electronic equipment as for example a mobile radio terminal, such as a mobile phone or the like, and in particular to the generation of text on such an electronic equipment. The present invention further relates to a method of generating text on an electronic equipment and to a computer program product comprising software code portions for performing the steps of the method.

### BACKGROUND OF THE INVENTION

Many electronic devices, such as mobile radio terminals, mobile phones, personal digital assistance or similar devices adapted for a communication in a wireless (cellular) communication system, as well as telephones connected to a fixed wired network, may enable the input of text information by a user and the transmission of text information messages via the wireless of the wired communication system. For example, the short messaging service (SMS) may allow text messages to be sent and received on mobile radio terminals. The text message can include words and/or numbers and is generated using a text editor module on the mobile radio terminal.

When creating a text message, the user may enter the characters for the message via a keyboard connected to a mobile radio terminal or any kind of telephone. Typically, the keyboard on small communication devices, such as portable telephones and the like may have only a limited number of keys. Mostly common are ten keys corresponding to the ten digits “0” to “9” and further control keys enabling a user to control the operation of the device. Each of the keys corresponding to one of the ten digits may also be allocated a number of characters. For example, in mobile phones typically employed in Europe, the keys corresponding to the digit “2” is also associated with the characters “A, B, C”. Two of the well known techniques for disambiguating characters typed on such a so-called ambiguous keyboard are known as “multi-tap” and “predictive text”. In the “multi-tap” system, the user may press each key a number of times depending on the letter that the user wants to enter. In the above example, pressing the key corresponding to the digit “2” once gives the character “A”, pressing the key twice gives the character “B” and pressing the key three times gives the character “C”. Usually, there is a predetermined amount of time within which the multiple keys strokes may be entered. This may allow for the key to be re-used for another letter when necessary. Further, pressing the key for a certain period of time usually gives the corresponding number. For instance, in the above example, pressing the key for two seconds may give the digit “2”.

When using a mobile radio terminal having a predictive text editor, the user may enter a word by pressing the keys corresponding to each character of the word exactly once and the text editor may include a dictionary which defines the words which may correspond to the sequence of key presses. For example, if the keyboard contains the keys “ABC”, “DEF”, “GHI”, “JKL”, “MNO”, “PQRS”, “TUV” and “WXYZ” and the user wants to enter the word “HELLO”, then he does this by pressing the keys “GHI”, “DEF”, “JKL”, “JKL”, and “MNO” only once respectively. The predictive text editor may then use the stored dictionary to disambiguate the sequence of keys pressed by the user into candidate words or candidate text. The dictionary usually also includes frequency of use statistics associated with each word which may allow the predictive text editor to choose the most likely word corresponding to the sequence of keys. If the predicted word is wrong then the user can scroll through a list of candidate words or candidate text to select the correct word he intends to input.

Electronic equipment such as mobile radio terminals and other devices having predictive text editors are becoming more and more popular because they may reduce the number of key presses required to enter a given word compared to those that use multi-tap text editors. However, one of the problems with predictive text editors may be that there are a large number of short words which map to the same key sequence. A user therefore sometimes may have to scroll through a long list of text candidates corresponding to the keys which are pressed if the predictive text editor does not predict the correct word on the top of the list of candidate words.

### SUMMARY OF THE INVENTION

An object of some embodiments of the present invention may be to provide an electronic equipment and a method of generating text on an electronic equipment, which may increase the speed and reliability of generating text on an electronic equipment.

The above object may be achieved by an electronic equipment according to claim 1, comprising a text input device enabling a user to input text information, a predictive text device adapted to determine at least one predictive text candidate on the basis of input text information, a camera device adapted to capture a moving image of the user, a detecting device adapted to detect at least one word or word part on the basis of a user's lip movement in the captured moving image, a determining device adapted to determine at least one most likely text on the basis of the at least one predictive text candidate determined by the predictive text device and the at least one word or word part detected by the detecting device and a display device adapted to display the at least one most likely text determined by the determining device.

Some embodiments of the present invention may be particularly advantageous in electronic equipment which are already equipped with a camera device, such as mobile phones, personal digital assistants, and the like. Some embodiments of the present invention may enable relatively quick input and generation of text in such equipment even in noisy environments and/or in circumstances in which a user may wish to keep the input text secret to his or her environment. Particularly in mobile phones or personal digital assistants in which cameras are already installed, some embodiments of the present invention can be implemented in an easy and cost effective manner.

Advantageously, the detecting device may be adapted to detect the at least one word or word part on the basis of the at least one predictive text candidate determined by the predictive text device. Hereby, instead of determining all possible words or word parts from the user's lip movement, the at least one predictive text candidate determined by the predictive text device may be used to prioritise the at least one word or word parts detected from the user's lip movement.

Further advantageously, the determining device may be further adapted to use information about previously input text to determine the at least one most likely text. Hereby, stored statistics about previously input text by the user may be used to put the most likely text on top of a list which is displayed to a user.

Further advantageously, the determining device may be further adapted to use reliability information about the detection of the at least one word or word part on the basis of a user's lip movement in the captured moving image when determining the at least one most likely text. Hereby, the reliability information may be advantageously provided by a quality detection device adapted to detect the quality of the captured moving image. Further advantageously, the quality detection device may detect the brightness of the captured moving image. For example, if the brightness of the captured moving image is quite low, the at least one word or word part detected from the user's lip movement may not be very reliable, and the determining device may consider the corresponding information to a lesser extend as compared to the at least one predictive text candidate determined by the predictive text device.

Advantageously, the electronic equipment according to some embodiments of the present invention may be a mobile radio terminal, such as for example a mobile phone or a personal digital assistant or the like adapted for a wireless communication in a wireless cellular communication system. It is to be understood, however, that some embodiments of the present invention can also be realised in a wired telephone for indoor use or the like.

The above objects may further be achieved by a method of generating text on an electronic equipment, comprising the steps of detecting the input of text information by a user determining at least one predictive text candidate on the basis of the input text information, capturing a moving image of a user, detecting at least one word or word part on the basis of a user's lip movement in the captured moving image, determining at least one most likely text on the basis of the determined at least one predictive text candidate and the at least one word or word part detected in the detecting step, and displaying the determined at least one most likely text.

Advantageously, in the detecting step, the at least one word or word part may be detected on the basis of the determined at least one predictive text candidate.

Further advantageously, information about previously input text may be used to determined the at least one most likely text.

Further advantageously, reliability information about the detection of the at least one word or word part on the basis of a user's lip movement in the captured moving image may be used when determining the at least one most likely text. Hereby, the reliability information may be advantageously provided by a quality detection step in which the quality of the captured moving image is detected. Advantageously, in the quality detection step the brightness of the captured moving image may be detected.

Some embodiments of the present invention further relate to a computer program product directly loadable into the internal memory of an electronic equipment, comprising software code portions for performing the steps of the method of generating text according to some embodiments of the present invention, when said product is run on the electronic equipment.

In the context of the present specification, the term electronic equipment may include portable radio communication equipment. The term portable radio communication equipment, which is also referred to as mobile radio terminal, may include all equipments such as mobile telephones, pagers, communicators, i.e. electronic organisers, smart phones or the like.

It should be emphasised that the term “comprises/comprising” when used in the present specification is taken to specify the presence of stated features, integers, steps or components, but does not preclude the presence or edition of one or more other features, integers, steps, components or groups thereof.

The present invention will be explained in more detail under following detailed description of an preferred embodiment thereof in relation to the enclosed drawing, in which a schematic block diagram of an electronic equipment according to some embodiments of the present invention is shown.

### BRIEF DESCRIPTION OF THE DRAWINGS

FIG. 1 shows a schematic block diagram of electronic equipment according to some embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention, and is further described in detail below. In the drawings, like numbers refer to like elements.

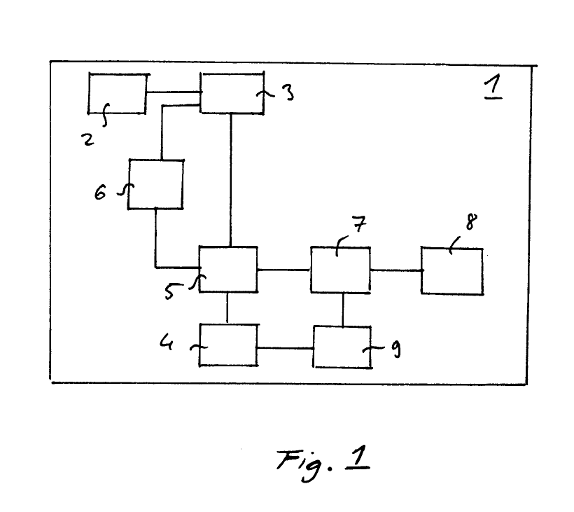

FIG. 1 illustrates electronic equipment according to some embodiments of the present invention. Referring now to FIG. 1, the electronic equipment 1 is for example a mobile phone for a wireless cellular communication system. It has to be understood that the electronic equipment 1 comprises all elements and functionalities necessary for each normal operation. For example, in case that the electronic equipment 1 is embodied as a mobile terminal for a wireless communication, it comprises all necessary elements for the communication in a wireless communication system. However, for the sake of clarity, enclosed figure only shows and the following description only explains the elements necessary for the implementation of some embodiments of the present invention.

The electronic equipment 1 comprises an input device 2, such as a keypad with a plurality of input keys, whereby each of the input keys may be allocated several characters or digits. The input device 2 enables the user to input text information by pressing or selecting the respective input keys. The input device 1 and the other control functionalities of the electronic equipment 1 support a predictive text input which is embodied in a predictive text device 3 of the electronic equipment 1. The predictive text device 3 is part of or controls the predictive text editor which is able to determine at least one predictive text candidate on the basis of input text information. For example, the predictive text device 3 is able to determine one or more text candidates, i. e. in combination of characters or letters, from the sequence of key strokes the user performs on one or more input keys of the input device 2. Hereby, the predictive text device 3 is in connection and communication with a word data base 6, in which all possible words in various languages which are supported by the predicted text editor are stored. The word data base 6 can additionally store statistical information about the frequency of use of the various words in order to enable the predictive text editor to present the most likely text a user wishes to input. It has to be noted that the predictive text device 3 not only is adapted to determine the most likely predictive text candidate with the number of characters or letters according to the number of key strokes which the user performed on the input device 2, but may also present a number of word completion candidates to user, i. e. completed words even though user did not yet input all the characters of a word. Further, the predicted text device may also be adapted to show the user a list of possible candidates for the next word.

The electronic equipment 1 further comprises a camera device 4 which is adapted to capture a moving image of a user. The camera device 4 is connected to a detecting device 5 which is adapted to detect at least one word or word part on the basis of a user's lip movement in the captured moving image. Thus, the detecting device 5 is adapted to using the information captured from the movement of the lips of the user to detect parts of words or entire words. Hereby, the detecting device 5 is connected to the word data base 6 in order to be able to determine the word parts or words corresponding to the lip movement.

The word parts or words detected from the detecting device 5 and the one or more predictive text candidates determined by the predictive text device 3 are then processed by a determining device 7 in order to determine at least one most likely text which the user intends to input. The at least one most likely text determined by the determining device is then displayed on a display device 8. It is to be noted that the determining device may determine a number of most likely text candidates and present the user on the display device 8 a list of most likely text candidates so that the user can choose which of the presented text information he would like to use. Hereby, the determining device may present the list of most likely text candidates to a user in the order of probability using statistical information about the frequency of the use of the various text information by a user stored in the word data base 6.

In order to accelerate the determination of at least one most likely text by the determining device 7, the detecting device 5, when detecting and determining at least one word or a word part on the basis of the lip movement of a user can use the information of the at least one predictive text candidate determined by the predicted text device 3 in order to pre-select or prioritise the selection of word parts or words against which the lip movement of the user is compared.

The electronic equipment 1 further comprises a quality detection device 9 which is adapted to detect the quality of the captured moving image. For example, the quality detection device 9 could be connected to the camera device 4 in order to determine the quality of the captured moving image. Alternatively, the quality detection device 9 could be adapted to determine the resolution or any other parameter characterising the quality of the image captured by the camera device 4. The determining device 7 would then be adapted to use the quality information derived by the quality detection device 9 for the determination of the at least one most likely text. For example, if the quality information characterises a low quality of the captured moving image, the contribution of the at least one word or word part supplied by the detecting device 5 could be reduced as compared to the at least one predictive text candidate provided by the predictive text device 3. For example, if the surrounding of the electronic equipment 1 is quite dark, the detection of the lip movement of a user is not very reliable or accurate so that the correspondingly derived information is also not very reliable and should not be used for the most likely text input by the user. If the brightness of the environment around the electronic equipment 1 falls below a certain threshold, the detecting device adapted to the attacked word or word parts on the basis of the user's lip movement could even be completely switched of. Additionally, the electronic equipment 1 comprise a switch enabling a user to completely switch the detecting device 5 of in case that he does not want to use it.

As stated above, the determining device 7 can determine and cause the display device 8 to display only one or a few most likely text information or words using the predictive text information, the lip movement information and eventually the statistically information about previously input words. Alternatively, the determining device 7 can cause the display device 8 to display the entire list of available and eventually matching text parts or texts in an order in which the most likely once are displayed in the beginning and to leased likely once or displayed in the end of the list.

It is to be noted that the electronic equipment 1 may comprise a control device, such as a microprocessor, a micro controller or the like in order to control the various flunctionalities of the devices explained above. Further, the various devices explained above or at least some of them, may be implemented as software code portions loaded into a memory of the electronic equipment 1 and adapted to perform the above described functionalities and method steps.

As will be appreciated by one of skill in the art, the present invention may be embodied as devices, methods, and computer program products. Accordingly, the present invention may be embodied in hardware and/or in software (including firmware, resident software, micro-code, etc.). Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described below with reference to flowchart illustrations and/or block and/or flow diagrams of methods according to embodiments of the invention. It should be noted that the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and/or the relevant art, and will not be interpreted in an idealized or overly formal sense unless expressly so defined herein.

The present invention has been described above with reference to specific embodiments. However, other embodiments than the above described are possible within the scope of the invention. Different method steps than those described above, performing the method by hardware or software, may be provided within the scope of the invention. The different features and steps of the invention may be combined in other combinations than those described. The scope of the invention is only limited by the appended patent claims.

That which is claimed:

1. An electronic device, comprising:
a text input device enabling a user to input text information;
a predictive text device configured to determine at least one predictive text candidate based on the input text information;
a camera device configured to capture a moving image of a user;
a detecting device configured to detect at least one word or word part based on a user's lip movement in the captured moving image;
a determining device configured to determine at least one most likely text based on the at least one predictive text candidate determined by the predictive text device and the at least one word or word part detected by the detecting device; and
a display device configured to display the at least one most likely text determined by the determining device.

2. An electronic device according to claim 1, wherein the detecting device is configured to detect the at least one word or word part based on the at least one predictive text candidate determined by the predictive text device.

3. An electronic device according to claim 1, wherein the determining device is further configured to use information about previously input text to determine the at least one most likely text.

4. An electronic device according to claim 1, wherein the determining device is further configured to use reliability information about the detection of the at least one word or word part based on a user's lip movement in the captured moving image when determining the at least one most likely text.

5. An electronic device according to claim 4, wherein the reliability information is provided by a quality detection device configured to detect the quality of the captured moving image.

6. An electronic device according to claim 5, wherein the quality detection device detects the brightness of the captured moving image.

7. An electronic device according to claim 1, wherein the electronic equipment is a mobile radio terminal.

8. A method of generating text on an electronic device, the method comprising:
detecting an input of text information by a user;
determining at least one predictive text candidate based on the input text information;
capturing a moving image of a user;
detecting at least one word or word part based on a user's lip movement in the captured moving image;
determining at least one most likely text based on the determined at least one predictive text candidate and the at least one word or word part detected in the detecting step; and
displaying the determined at least one most likely text.

9. A method according to claim 8, wherein detecting the at least one word or word part comprises detecting the at least one word or word part based on the determined at least one predictive text candidate.

10. A method according to claim 8, wherein information about previously input text is used in determining the at least one most likely text.

11. A method according to claim 8, wherein reliability information about the detection of the at least one word or word part based on a user's lip movement in the captured moving image is used in determining the at least one most likely text.

12. A method according to claim 11, the method further comprising:
detecting a quality of the captured moving image,
wherein the reliability information is provided based on the detected quality.

13. A method according to claim 12, wherein in the quality detection step the brightness of the captured moving image is detected.

14. A computer program product directly loadable into the internal memory of an electronic device, comprising:
computer readable program code configured to perform the method of claim 8.
